(19) United States
(12) Patent Application Publication
(10) Pub. No.: US 2013/0280607 A1
(43) Pub. Date: Oct. 24, 2013

(54) BATTERY CELL HAVING REDUCED CELL INDUCTANCE

(71) Applicants: Peter Feuerstack, Ludwigsburg (DE); Erik Weissenborn, Stuttgart (DE); Martin Kessler, Schwaebisch Gmuend (DE)

(72) Inventors: Peter Feuerstack, Ludwigsburg (DE); Erik Weissenborn, Stuttgart (DE); Martin Kessler, Schwaebisch Gmuend (DE)

(73) Assignee: ROBERT BOSCH GMBH, Stuttgart (DE)

(21) Appl. No.: 13/977,876

(22) PCT Filed: Nov. 14, 2011
(86) PCT No.: PCT/EP2011/070009

§ 371 Date: Jul. 1, 2013

(30) Foreign Application Priority Data
Dec. 29, 2010 (DE) 102010064301.7

(51) Int. Cl. H01M 2/26

(52) U.S. Cl. CPC H01M 2/26
USPC 429/211

(57) ABSTRACT

The invention relates to a battery cell (101; 101; 101″; 101″′), comprising a first electrode foil (102) and a second electrode foil (103), which are rolled up together with an interposed separator to form a roll 104; 104″′), a first (105; 105″; 105″′) and a second terminal connector (106; 106″; 106″′) for connecting the battery cell (101; 101; 101″; 101′) to external circuitry, a first connecting element (107; 107; 107′), which electrically connects the first terminal connector (105; 105″; 105″′) to the first electrode foil (102), and a second connecting element (108; 108; 108″′), which electrically connects the second terminal connector (106; 106″; 106′) to the second electrode foil (103). According to the invention, the two connecting elements (105, 107; 105″, 107″; 105″′, 107″′) make contact with the respective electrode foil (102; 103) on a first end face (110; 110′) of the roll.

### BACKGROUND OF THE INVENTION

The invention relates to a battery cell, in particular a rechargeable battery cell.

In the majority of areas where battery cells are used, disregarding a low ripple proportion, approximately direct current is drawn off from and/or supplied to said battery cells.

U.S. Pat. No. 5,642,275 A discloses a battery system having an integrated alternating current converting function, in which a row of circuit breakers having separate direct current voltage sources in the form of batteries is provided. Battery systems of this type that are also frequently described as multilevel cascaded inverters render it possible to achieve single-phase or multi-phase systems that comprise a higher degree of efficiency and a higher level of reliability than conventional alternating current converting arrangements.

However, if a battery system of this type is used for example to control an electric machine, a quick conversion of the current flowing through the direct current voltage sources and/or bypassing the direct current voltage sources is required in order to vary the phase voltage. However, as the proportion of the current being converted increases, so does also the influence of the inductance of the direct current voltage sources and as a result when using battery modules the influence of the inductance of the individual battery cells (cell inductance) also increases. In particular, the cell inductances in combination with high currents during switching operations lead to a high level of energy dissipation that is converted into heat in the circuit breakers. As a consequence of the repeated occurrence of switch operations this leads to high thermal dissipation losses in the switches and consequently to a reduced degree of efficiency of the battery system. If the individual battery cells are connected in series in a battery module, then the individual cell inductances are summated and this leads to a correspondingly higher level of thermal dissipation loss. In some applications, an excessively high inductive proportion of the impedance of the battery cells also makes an additional buffer capacity necessary.

Electromagnetic fields associated with distributed cell inductances are also emitted during each switch operation, which without corrective measures could lead to malfunctions in adjacent electronic components, so that complex additional switch measures are frequently necessary in order to comply with EMC regulations (EMC=electromagnetic compatibility).

### SUMMARY OF THE INVENTION

The present invention provides a battery cell, in particular a rechargeable battery cell, having a first electrode foil and a second electrode foil that together with an interposed separator are rolled up to form a roll, a first terminal connection and a second terminal connection for connecting the battery cell to external circuitry, a first connecting element that electrically connects the first terminal connection to the first electrode foil, and a second connection element that electrically connects the second terminal connection to the second electrode foil. In accordance with the invention, the two connecting elements contact the respective electrode foil on a first end face of the roll.

### Advantages of the Invention

The total inductance of a battery module is defined on the one hand by the inductances of the individual battery cells (cell inductances) and on the other hand by the inductance of the interconnections of these battery cells. The invention is based on the fundamental idea, of arranging the connecting elements, which electrically connect the electrode foils to the respective terminal connection, on the same end face of the roll and also to contact the electrode foils at that site. In this manner, the gap and consequently the enclosed surface area between the two terminal connections are reduced, which leads to a considerable reduction of the cell inductance. This in turn leads to a reduced level of thermal dissipation loss in the circuit breakers and consequently to a greater level of efficiency of the battery system. The construction in accordance with the invention of the battery cell also reduces the number of electromagnetic malfunctions.

In order to avoid undesired wave effects, resonances or reflections on the second end face of the roll, which second end face lies opposite the first end face, it is provided in accordance with an embodiment of the invention to electrically mutually connect in each case the individual layers of the first electrode foil and the second electrode foil on the second end face of the roll, which second end face lies opposite the first end face.

This can be achieved in a particularly simple manner by virtue of the fact that the roll is folded in such a manner that a first end surface of the previously unfolded roll and a second end surface of the previously unfolded roll come to lie adjacent to one another after being folded into a roll, in particular directly adjacent to one another, such that the first end face of the roll that has been produced in this manner is formed by the two end surfaces. However, if it is decided not to perform a fold of this type, the electrical connection of the electrode foils can also be made in a different manner, for example with the aid of one or more separate contacting elements.

In accordance with an embodiment of the invention, the electrode foils are offset with respect to one another when rolled up, so that the first end surface of the roll is formed by means of the layers of the first electrode foil and the second end surface of the roll is formed by the layers of the second electrode foil. The two connecting elements are embodied in this case in a planar manner and contact at a respective end surface a plurality of layers, in particular all layers, of the respective electrode foil.

In this case, as far as the inductive portion of the layers is concerned, a parallel connection is virtually produced, which leads to a corresponding reduction of the resulting inductance. In the case of a cell roll of a battery cell, in which in a conventional manner a few meters of foil are rolled up, this leads to a high number of “parallel connected” layers and consequently to a parasitical inductance that is negligible in this respect. Both the extremely small amount of remaining inductance and also the fact that all the layers are contacted in a uniform manner prevents wave propagation effects from occurring. Furthermore, the fact that all layers are contacted renders it possible to reduce the contacting resistance and to provide a homogenous current distribution which together lead to reduced ohmic losses.

The effects can be further enhanced, in that the connecting elements contact the respective electrode foil in each case on the entire end surface of the roll.

In order to achieve a low inductive interconnection also in the area of the terminal connections, it is also possible to embody the terminal connections in a planar manner.

It is possible to implement the invention in a particularly simple manner using manufacturing technology if the connecting elements are embodied in each case as one part with the terminal connections.

Further features and advantages of embodiments of the invention are evident from the description hereinunder with reference to the attached drawings.

### BRIEF DESCRIPTION OF THE DRAWINGS

In which:

FIG. 1 shows a schematic perspective illustration of a battery cell as is known from the prior art,

FIG. 2 shows a schematic perspective illustration of a battery cell in accordance with the invention in accordance with a first embodiment,

FIG. 3 shows a schematic perspective illustration of a battery cell in accordance with the invention in accordance with a second embodiment,

FIG. 4 shows a schematic perspective illustration of a battery cell in accordance with the invention in accordance with a third embodiment,

FIG. 5 shows a schematic perspective illustration of a roll of a battery cell in accordance with the invention in accordance with a fourth embodiment prior to the fold being made and contact being established, and

FIG. 6 shows a schematic perspective illustration of a battery cell in accordance with the invention in accordance with the fourth embodiment.

Like components and components that function in a like manner are provided with like reference numbers in each case in the figures.

### DETAILED DESCRIPTION

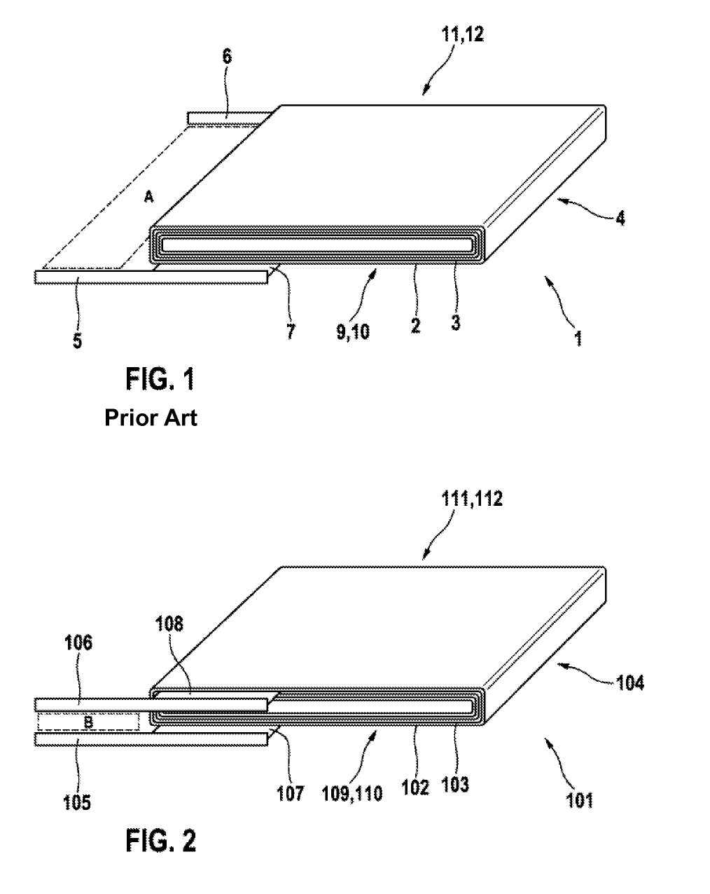

FIG. 1 shows a schematic illustration of a battery cell 1 as is known from the prior art. The battery cell 1 comprises a first electrode foil 2 and a second electrode foil 3 that together with an interposed separator, which is not illustrated itself, are rolled up to form a roll 4 that comprises a plurality of layers. A first terminal connection 5 and a second terminal connection 6 are provided in order to connect the battery cell 1 to external circuitry, for example a further battery cell or a circuit breaker. The terminal connections 5 and 6 are electrically connected to the first electrode foil 2 or the second electrode foil 3 respectively by way of a first connecting element 7 or respectively a second connecting element that is not visible owing to the fact that the illustration is a perspective view. The connecting elements are frequently also described as “tabs”. The first connecting element 7 contacts the first electrode foil 2 on a first end surface 9 of the winding 4, which end surface simultaneously forms a first end face 10 of the entire roll 4. The second connecting element contacts the second electrode foil 2 on a second end surface 11 of the roll 4, which second end surface lies opposite the first end surface 9 and simultaneously forms a second end face 12 of the entire roll 4. As a consequence, a relatively large area A is formed between the two terminal connections 5 and 6 and this relatively large area leads to a relatively high parasitical inductance of the battery cell 1.

FIG. 2 shows a schematic illustration of a first embodiment of a battery cell 101 in accordance with the invention that can be embodied in particular as a rechargeable battery cell. The battery cell 101 comprises on the other hand a first electrode foil 102 and a second electrode foil 103, that together with an interposed separator, which is not illustrated itself, are rolled up to form a roll 104 that comprises a plurality of layers. A first terminal connection 105 and a second terminal connection 106 are provided in order to connect the battery cell 101 to external circuitry. The terminal connections 105 and 106 are also electrically connected to the first electrode foil 102 or the second electrode foil 103 respectively in the case of the battery cell 101 in accordance with the invention by way of a first connecting element 107 or a second connecting element 108 respectively. The first connecting element 107 contacts on the other hand the first electrode foil 102 on a first end surface 109 of the roll 104, which first end surface simultaneously forms a first end face 110 of the entire roll 104. In contrast to the battery cell as shown in FIG. 1 and known from the prior art, the second connecting element 108 contacts the second electrode foil 102 but not on a second end surface 111 of the roll 104, which second end surface lies opposite the first end surface 109 and simultaneously forms a second end face 112 of the entire roll 4 but rather on the same end face 110 on which the first electrode foil 102 is also contacted with the aid of the first connecting element 107. As a consequence, an area B that is considerably smaller in comparison to the arrangement as shown in FIG. 1 is formed between the two terminal connections 105 and 106 and this leads to a considerably reduced parasitical inductance of the battery cell 101.

In order to avoid undesired wave effects, resonances or reflections on the second end face 112 of the roll, the individual layers of the first electrode foil 102 and the second electrode foil 103 can be mutually electrically connected in each case on the second end face 112 of the roll, for example with the aid of contact elements that are not illustrated.

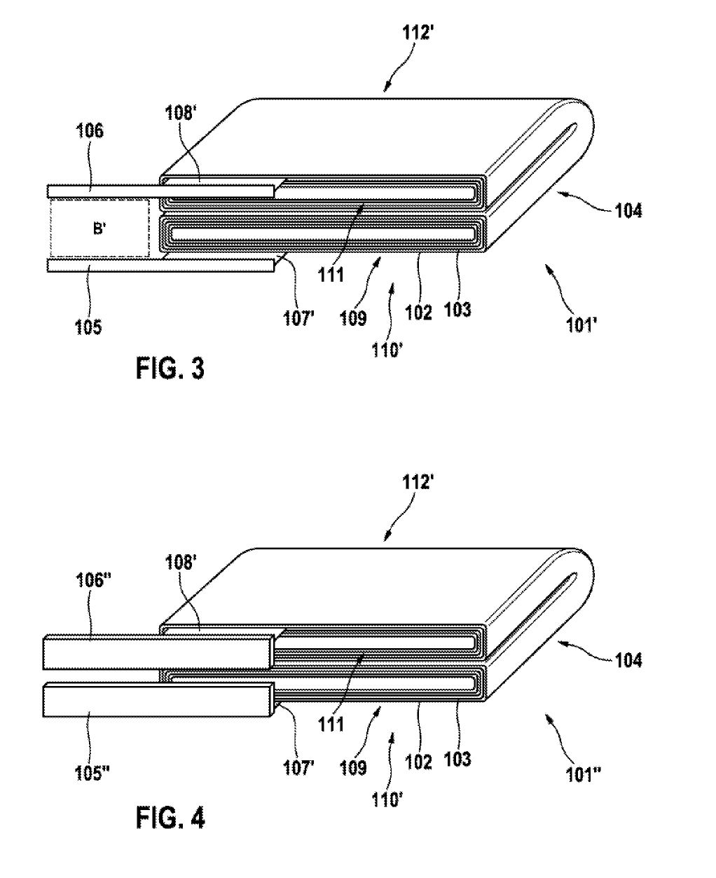

FIG. 3 shows a schematic illustration of a second embodiment of a battery cell 101′ in accordance with the invention in which the electrical connection between the individual layers of the first electrode foil 102 and the second electrode foil 103 is provided in a particularly elegant manner on a second end face 112′ of the roll 104, on which second end face the electrode foils 102, 103 are not contacted. The roll 104 is folded for this purpose in such a manner that the first end surface 109 and the second end surface 111 of the roll 104 come to lie adjacent to one another and in the illustrated exemplary embodiment even directly adjacent to one another. A first end face 110′ of the winding 104 is embodied in this case by means of the two end surfaces 109 and 111, whereas a second end face 112′ of the roll 104 is embodied by the “fold backs”. The terminal connections 105 and 106 are electrically connected to the first electrode foil 102 or the second electrode foil 103 respectively also in the case of this embodiment by way of a first connecting element 107′ or a second connecting element 108′ respectively. In a similar manner to the embodiment as shown in FIG. 2, the first connecting element 107′ contacts the first electrode foil 102 on the first end surface 109 of the roll 104. In contrast to the embodiment as shown in FIG. 2, the second connecting element 108′ contacts the second electrode foil 102 but on the second end surface 111 of the roll 104. However, as a result of the roll 104 being folded, the two electrode foils 102 and 103 are nonetheless contacted in a manner in accordance with the invention on the same, namely the first, end face 110′ of the roll 104. An area B′ that is considerably smaller in comparison to the arrangement as shown in FIG. 1 is also formed in the case of this embodiment between the two terminal connections 105 and 106 and this considerably smaller area leads to a considerably reduced parasitical inductance of the battery cell 101′.

A further reduction of the inductive portion of the impedance can be achieved in accordance with a third embodiment of a battery cell 101″ in accordance with the invention by virtue of the fact that terminal connections 105″ and 106″ that are embodied in a planar manner are used (cf. FIG. 4). The term ‘planar embodiment’ is understood in this case to mean in particular an embodiment in which a width bₜₑᵣₘᵢₙₐₗ of the terminal connections 105″ and 106″ is greater than half a width b_{end} of an end surface 109, 111 of the roll 104. The bₜₑᵣₘᵢₙₐₗ of the terminal connections 105″ and 106″ preferably corresponds substantially to the width b_{end} of the end surfaces 109, 111 of the roll 104.

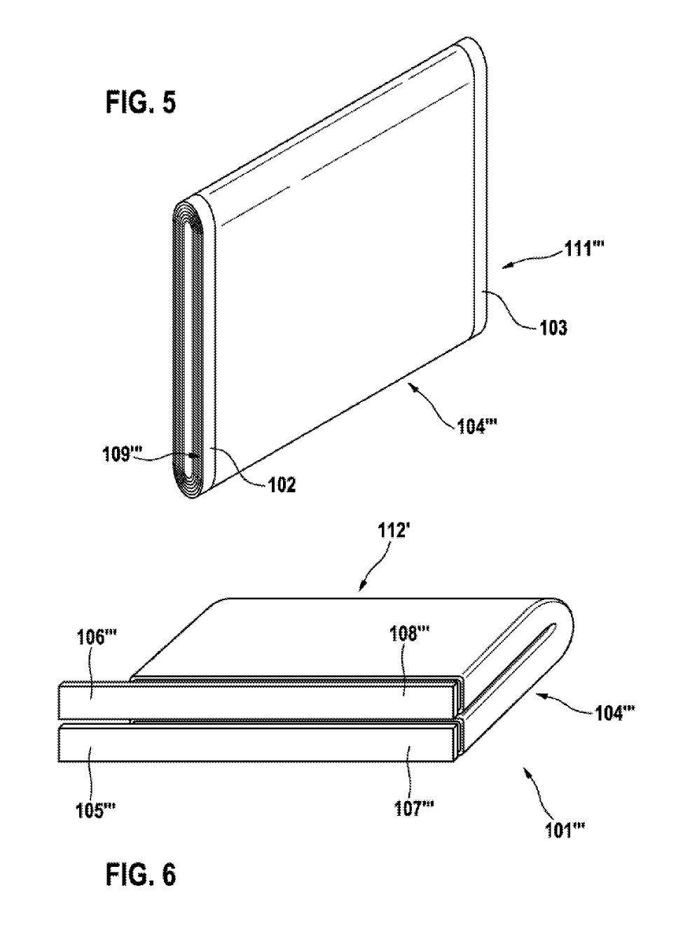

FIG. 5 shows a schematic illustration of a roll 104″′ in accordance with a fourth embodiment of a battery cell 101″′ in accordance with the invention prior to the fold being made and the contact being established. The roll 104″ differs from the roll 104 of the previous embodiments by virtue of the fact that the two electrode foils 102 and 103 are rolled up offset to one another, so that a first end surface 109″′ of the roll 104″′ is formed by means of the layers of the first electrode foil 102 and a second end surface 111″′ of the roll 104″′ is formed by means of the layers of the second electrode foil 103.

If a roll 104″′ of this type is folded according to the second and third embodiment of the invention, then the connecting elements 107″′ and 108″′ are embodied in a planar manner similar to that in the third embodiment and a plurality of layers, in particular all the layers, of the respective electrode foil 102 or 103 respectively contact in each case an end surface 109″′ or 111″′ respectively (cf. FIG. 5). The contact surface can in so doing also cover in each case the entire end surface 109″′ or 111″′ respectively. In the case of the illustrated embodiment variants, the connecting elements 107″′ and 108″′ are embodied as one part with in each case associated terminal connections 105″′ or 106″′ respectively.

1. A battery cell (101; 101′; 101″; 101″′) having:
a first electrode foil (102) and a second electrode foil (103) that together with an interposed separator are rolled up to form a roll (104; 104″′),
a first terminal connection (105; 105″; 105″′) and a second terminal connection (106; 106″; 106″′) for connecting the battery cell (101; 101′; 101″; 101″; 101′″) to external circuitry,
a first connecting element (107; 107′; 107″′) that electrically connects the first terminal connection (105; 105″; 105″′) to the first electrode foil (102), and
a second connection element (108; 108′; 108″) that electrically connects the second terminal connection (106; 106″; 106″′) to the second electrode foil (103),
characterized in that the first and second connecting elements (105, 107; 105″, 107″; 105″′, 107″′) each contact the respective electrode foil (102; 103) on a first end face (110; 110′) of the roll.

2. The battery cell as claimed in claim 1, characterized in that individual layers of the first electrode foil (102) and the second electrode foil (103) are in each case electrically mutually connected on a second end face (112; 112′) that lies opposite the first end face (110; 110′).

3. The battery cell as claimed in claim 2, characterized in that the roll (104; 104″′) is folded in such a manner that the first end face (110′) is formed by a first end surface (109; 109″′) of the roll (104; 104″′) and a second end surface (111; 111″′) of the roll (104; 104″′) , which end surfaces come to lie adjacent to one another.

4. The battery cell as claimed in claim 3, characterized in that the electrode foils (102, 103) are rolled up offset to one another, so that the first end surface (109″′) of the roll 104″′) is formed by the layers of the first electrode foil (102) and the second end surface (111″′) of the roll (104″′) is formed by the layers of the second electrode foil (103) and that the two connecting elements (107″′, 108″′) are embodied in a planar manner and a plurality of layers of the respective electrode foil (102; 103) contact in each case an end surface (109″′; 111″′).

5. The battery cell as claimed in claim 4, characterized in that the connecting elements (107″′, 108″′) contact the respective electrode foil (102; 103) in each case on the entire end surface (109″′; 111″′) of the roll (104″′).

6. The battery cell as claimed in claim 1, characterized in that the terminal connections (105″′, 106″′) are embodied in a planar manner.

7. The battery cell as claimed in claim 1, characterized in that the connecting elements (107″′, 108″′) are embodied in each case as one part with the terminal connections (105″′, 106″′).

8. The battery cell as claimed in claim 2, characterized in that the roll (104; 104″′) is folded in such a manner that the first end face (110′) is formed by a first end surface (109; 109″′) of the roll (104; 104″′) and a second end surface (111; 111″′) of the roll (104; 104″′), which end surfaces come to lie directly adjacent to one another.

9. The battery cell as claimed in claim 3, characterized in that the electrode foils (102, 103) are rolled up offset to one another, so that the first end surface (109″′) of the roll 104″′) is formed by the layers of the first electrode foil (102) and the second end surface (111″′) of the roll (104″′) is formed by the layers of the second electrode foil (103) and that the two connecting elements (107″′, 108″′) are embodied in a planar manner and all the layers of the respective electrode foil (102; 103) contact in each case an end surface (109″′; 111″′).

10. The battery cell as claimed in claim 5, characterized in that the terminal connections (105″′, 106″′) are embodied in a planar manner.

11. The battery cell as claimed in claim 10, characterized in that the connecting elements (107″′, 108″′) are embodied in each case as one part with the terminal connections (105″′, 106″′).
